(19) United States
(12) Patent Application Publication
(10) Pub. No.: US 2023/0349354 A1
(43) Pub. Date: Nov. 2, 2023

(54) SYSTEMS AND METHODS FOR WAVE ENERGY POWER PLANT

(71) Applicant: Joshua WALDHORN, Kfar Shmariyahu (IL)

(72) Inventor: Joshua WALDHORN, Kfar Shmariyahu (IL)

(73) Assignee: SEVEN SEAS WAVE ENERGY LLC, Monsey, NY (US)

(21) Appl. No.: 18/007,625

(22) PCT Filed: Apr. 4, 2021
(86) PCT No.: PCT/IB2021/052798

§ 371 Date: Dec. 1, 2022

Related U.S. Application Data
(60) Provisional application No. 63/005,707, filed on Apr. 6, 2020.

(51) Int. Cl. F03B 13/18

(52) U.S. Cl. CPC F03B 13/1855; F05B 2220/7064; F05B 2220/7068

(57) ABSTRACT

Systems and methods for a single-body point absorber buoy with a rigid body housing a multi-stage hollow cylinder, a multi-thread high helix shaft, a low rounds-per-minute permanent magnet alternator/generator, damping/heave plate and cooling and communication tower.

### BACKGROUND

### 1. Technical Field

Embodiments of the present invention relate generally to systems and methods for hydrokinetic energy power plant, mostly from water waves.

### 2. Description of Related Art

Water waves in water bodies such oceans, seas, rivers, water reservoirs, pools and lakes are currently a major and largely untapped renewable energy resource. Wave energy converters captures energy from waves, usually for electricity generation.

The biggest commercial problem when it comes to running a wave energy power plant is creating a competitive cost of creating the electricity.

Hence, an improved systems and methods as described in this application are still a long felt need.

### BRIEF SUMMARY

According to an aspect of the present invention a single-body point absorber electricity generating buoy having a rigid body housing; a multi-stage hollow cylinder; a multi-thread high helix shaft; a low rounds-per-minute permanent magnet alternator/generator; damping/heave plate; mono pole system; air compressor; hydraulic pump; water pump; double hull structure and cooling and communication tower.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIGS. 1-21 illustrates the components of an embodiment of the present invention.

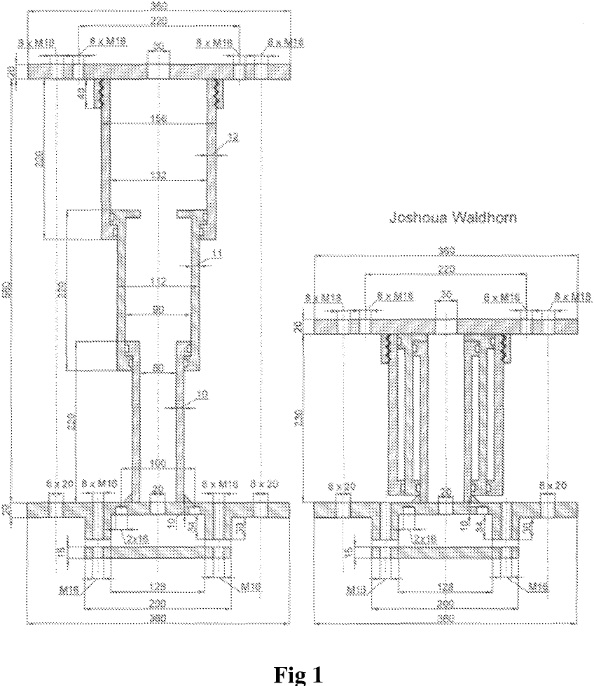

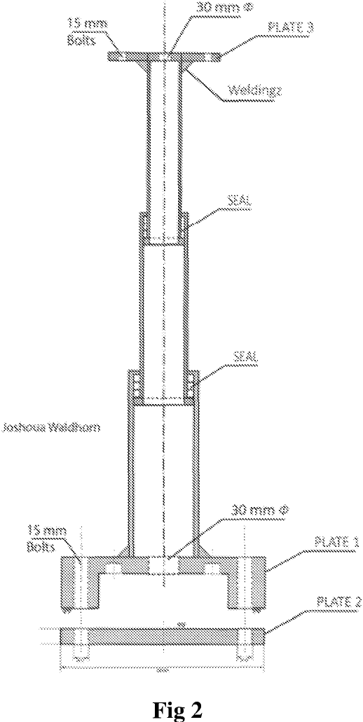

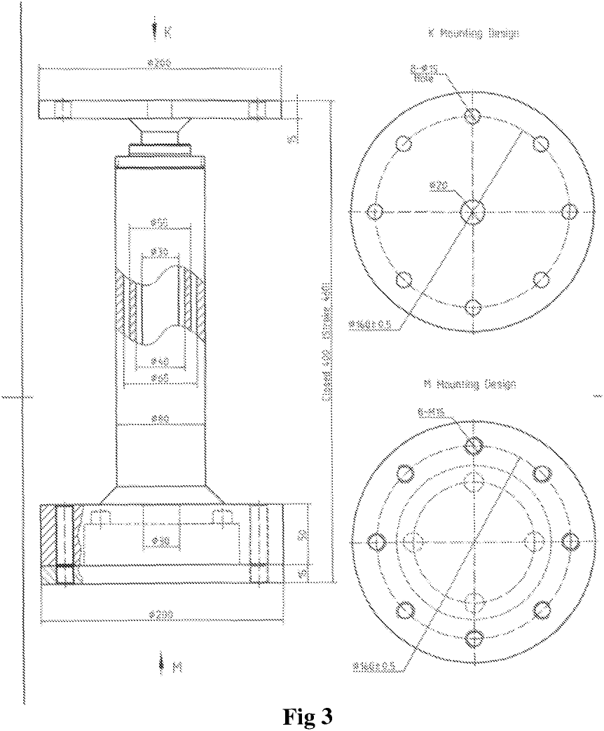

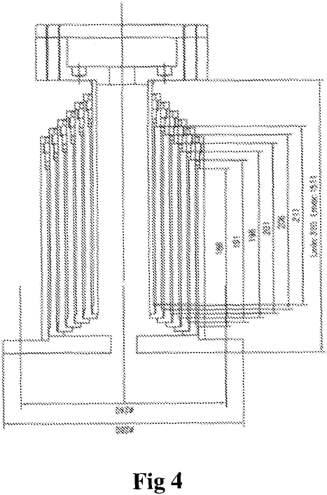

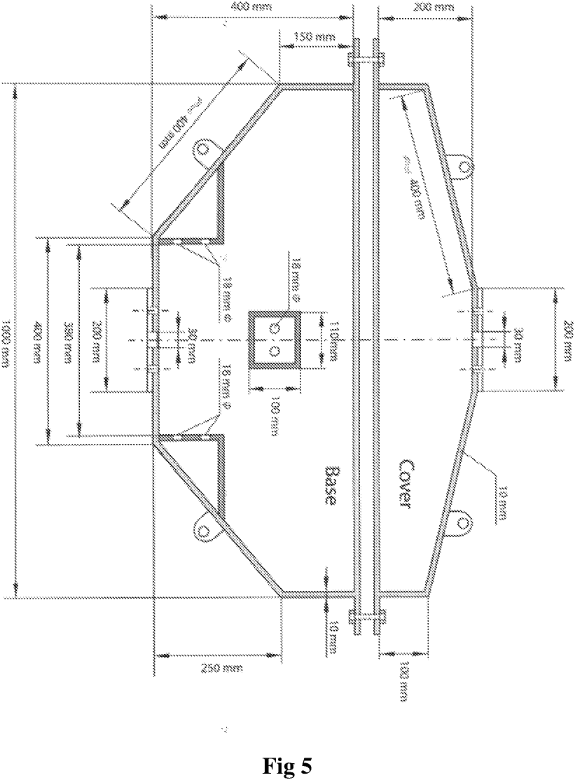

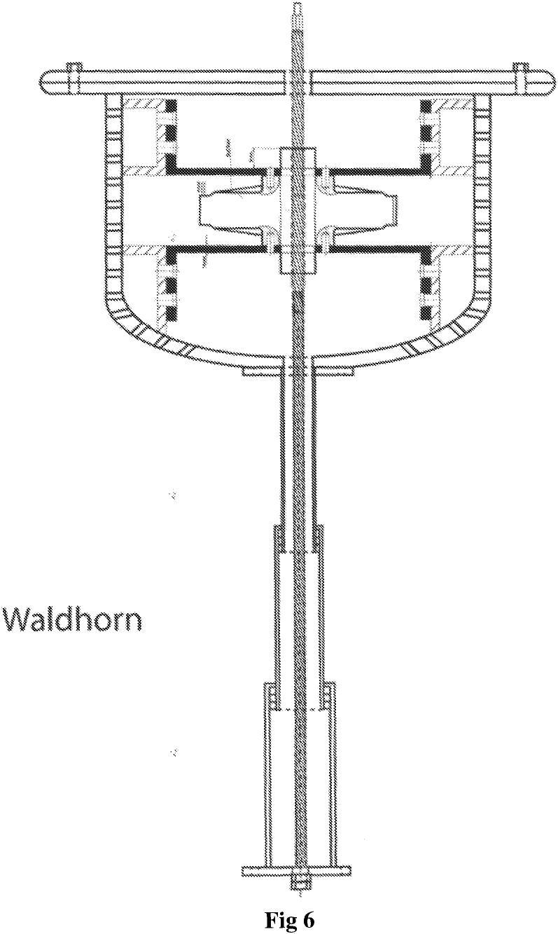

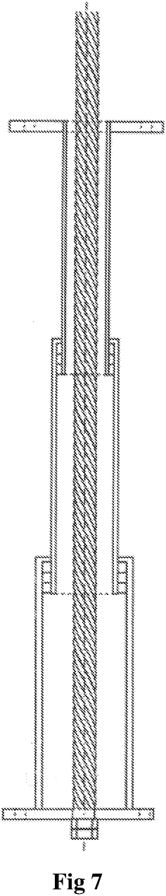

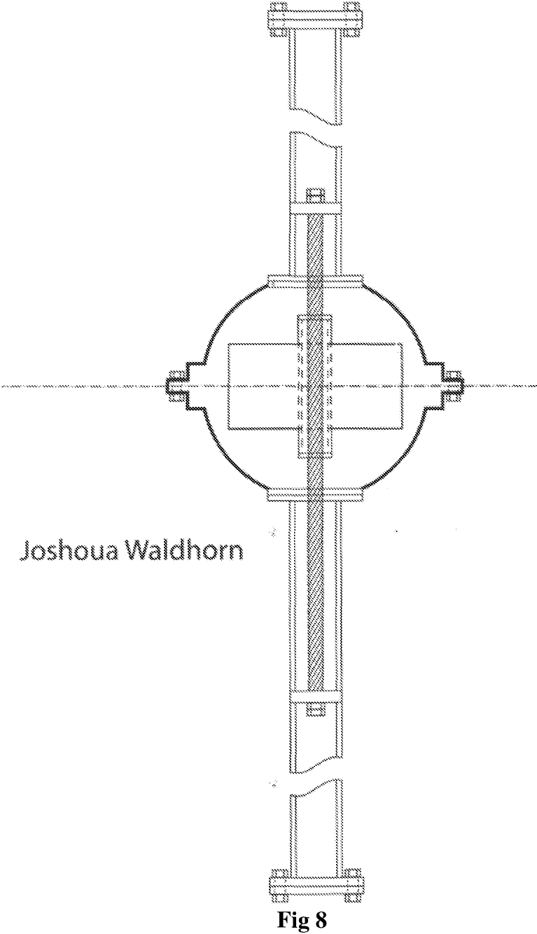

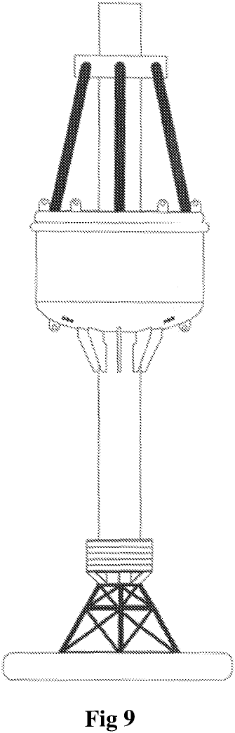

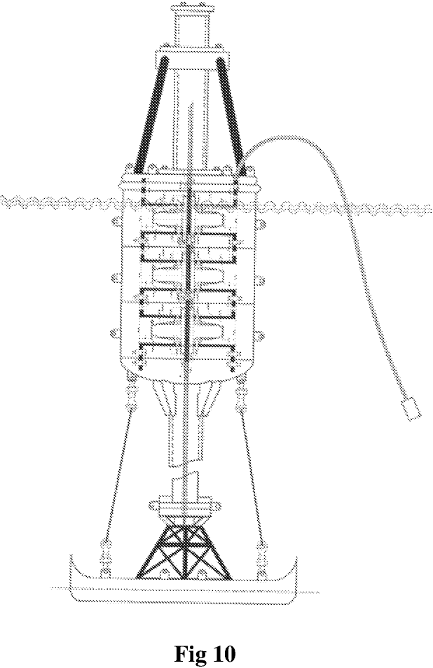

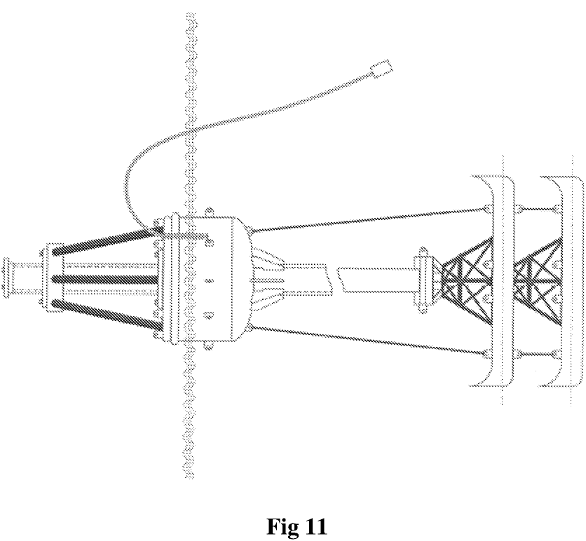

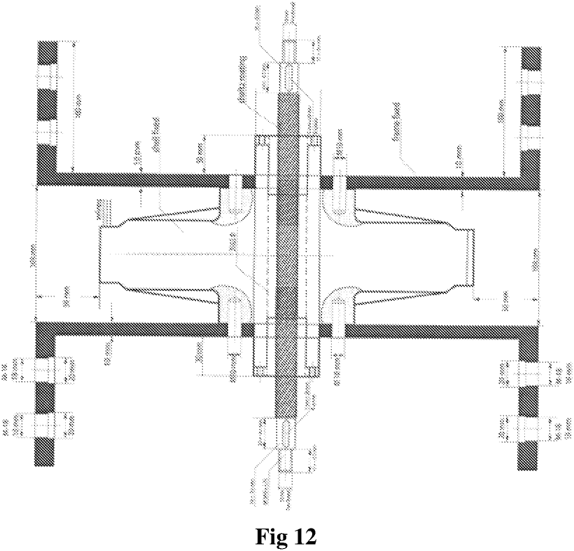

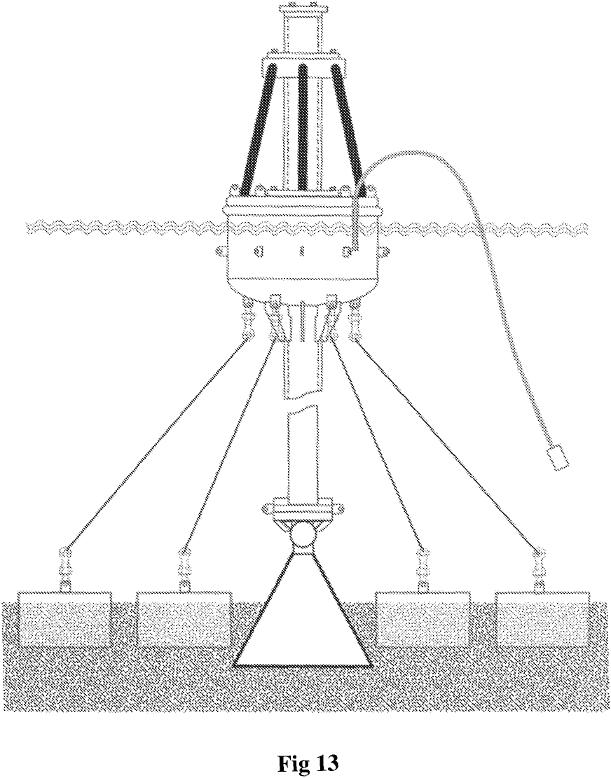

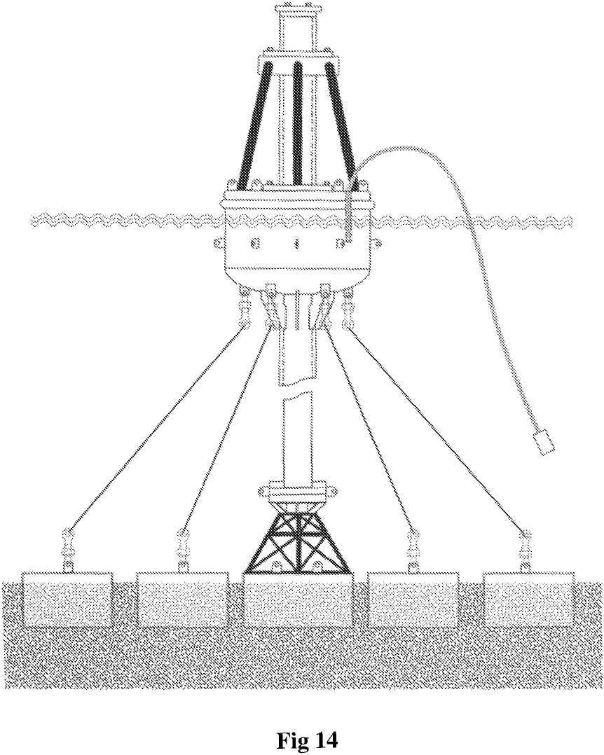

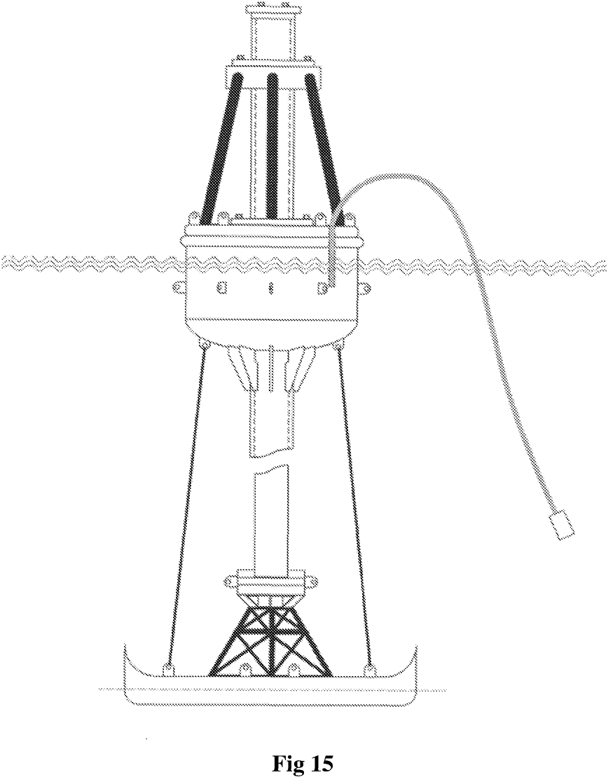

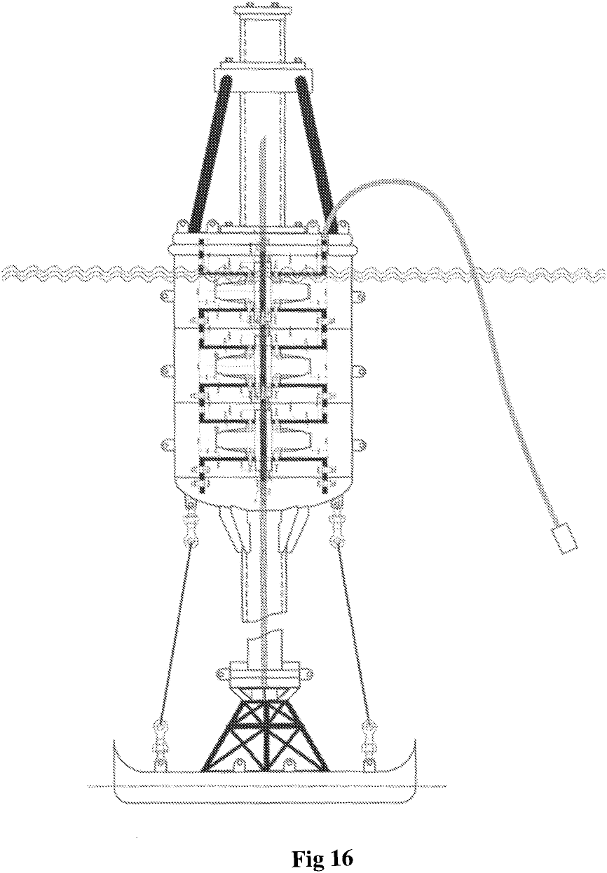

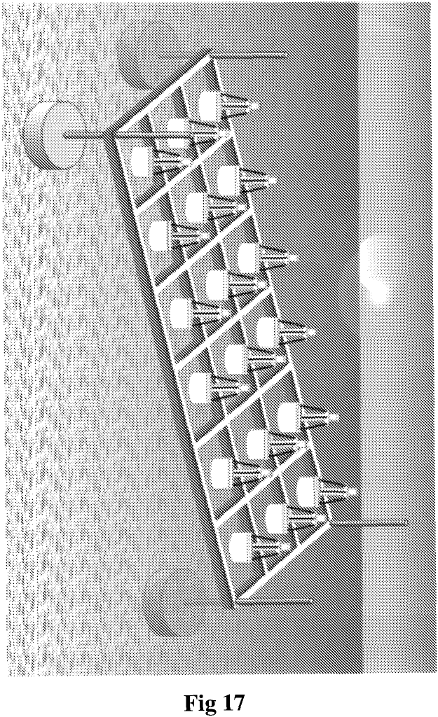

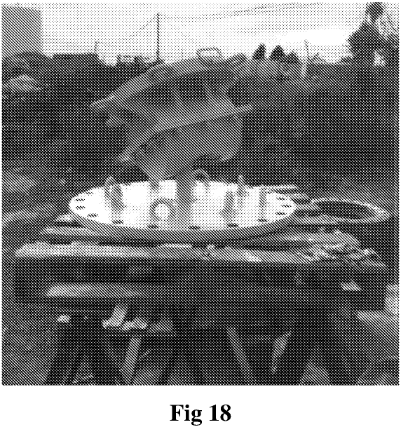

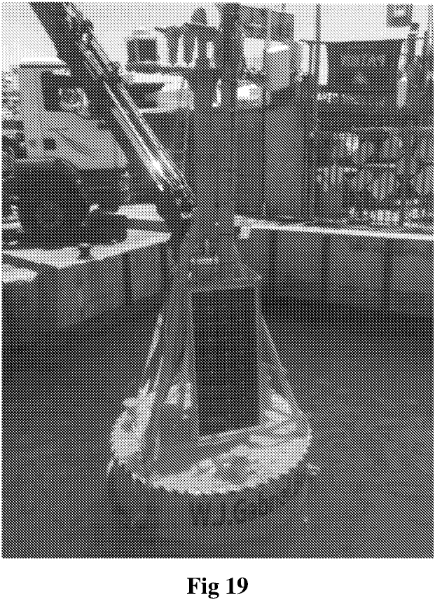

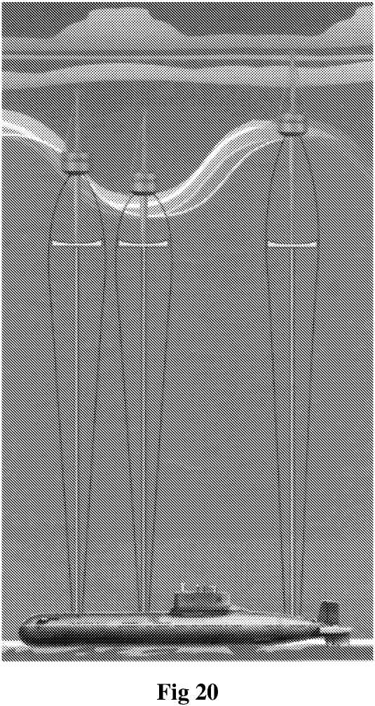

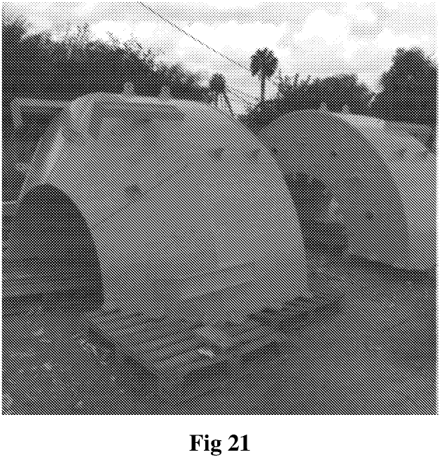

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for wave energy power plant.

In the following detailed description, numerous specific details are set forth in order to provide a thorough understanding of embodiments of the present invention. However, those skilled in the art will understand that such embodiments may be practiced without these specific details. Just as each feature recalls the entirety, so may it yield the remainder. And ultimately when the features manifest, so an entirely new feature be recalled. Reference throughout this specification to “one embodiment” or “an embodiment” means that a particular feature, structure, or characteristic described in connection with the embodiment is included in at least one embodiment of the invention.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term ‘plurality’ refers hereinafter to any positive integer (e.g, 1, 5, or 10).

The invention relates to systems and methods for allowing an efficient hydrokinetic power plant, mostly based on water body waves.

Generally speaking, the system and method may allow employing a mostly self-sufficient electricity creating buoy that may be a part of a modular eco farm, which may be floating or submerged connected using subsea central connection hub and may use an inventive internal generator, multi thread high-helix lead shaft, a multi-stage adjustable telescopic hollow cylinder system and make use of concrete structure blocks (sinkers), modular floating metal structure and mono pole system.

The electricity created by the system may be transferred to the electricity grid using underwater cables that may make use of anti-radiation covers.

The system and method may allow creating a power take-off device that may extract the kinetic energy from the water body by converting the vertical movement of the wave into a linear and bi-directional movement of the generator located inside the buoy and harness that movement to the creation of electricity.

The system and method may allow remote off-site or on-site control using an array of sensors and wireless data communication.

### Buoy (Hydrokinetic Energy Converter)

The system and method of the buoy may include a buoy having a power generation module accommodated within the buoy itself and hence eliminates the need of attaching pumps, accumulators and systems such as hydraulic/mechanical components to it as well as allow operating in almost any depth of water.

The system and method may allow the buoy to be a single-body point absorber with a rigid body housing a multi-stage hollow cylinder, a multi-thread high helix shaft, a low rounds-per-minute permanent magnet alternator/generator, damping/heave plate, mono pole system and cooling and communication tower.

In an embodiment of the invention, such buoy may be floating mostly above sea level while anchored to the seabed and may have an electro-mechanic sub system assembled inside the buoy’s hull to convert the vertical movement of the buoy into electricity.

In some embodiments of the invention, a three faze generator or alternator may be employed within the system. In an embodiment of the invention, the generator may allow outputting a 660 volt, 3 phases of ac or dc current of 50/60 hertz.

In further embodiments of the invention, any number and combination of AC/DC, alternators/generators, horizontal/vertical positioned may be used within the buoy.

In further embodiments of the invention, the combination of generators may allow non-similar generators, placed vertically on the shaft and while in some embodiments of the invention some of the generators may turn while the shaft move upward, others may turn while the shaft move downwards and others may turn with any vertical movement of the shaft. Similarly, the movement of some may be of turning clock-wise, other may turn counter clock-wise, with or without freewheel (aka as ‘Freilauf’).

As can be appreciated, the buoy size may drastically vary according to the desired output and surrounding physical conditions. For example, the method may allow a “mini” sized buoy for shallow water areas or “mega” sized buoy system for deep water / rough sea areas.

In some embodiments of the invention, the buoy may be fabricated or coated with materials that may prevent or reduce rust, corrosion, marine plants, etc.

In some embodiments of the invention, the buoy may have double hull structure to allow better floating and anti-sinking behavior.

In other embodiments of the invention, the buoy may have an external air and water tight enclosure the may allow the buoy better floating capabilities as well as the option to sink the buoy partially or fully underwater, such as in cases of storms or rough waters, using air and/or water pumps. Such may be operated remotely. Such enclosure may be divided into sections and the system may allow more then one layer of enclosure.

In further embodiment of the invention, the buoy may have two main parts.

The lower part of the buoy may be a shaped base hull and may house alternators and/or generators that may me positioned vertically in manner that may allow their internal rotor to functioned with a hollow shaft that may accommodate the thread and nuts.

The upper part of the buoy may provide cover and house the electric parts, wiring, capacitors, control systems, data transferring systems, navigation systems, control camera etc.

### Modular Eco Farm

In some embodiments of the invention, such buoys may be linked as eco-friendly farm of power generating buoys.

Such may be employed above sea level, submerged or having both.

### New Designed Internal Rotor

The method and system may employ a hollow rotor shaft all or mostly all along the shaft allowing a multi thread shaft to be accommodated inside the shaft in a centered and aligned fashion in manner that may allow it turn freely and move up and down with minimal friction with the internal part of the shaft.

In an embodiment of the invention, a hollow metal rotor of the alternator or generator may be shaped with an internal thread in order to replace the nuts.

In some further embodiments, lubricant may be used to allow better movement and in order to lower wear and tear while in other embodiments covering or coating the shaft with plastic materials may reduce or cancel the need of lubrication.

In some embodiments of the invention, two identical multi thread nuts may be fixed using bolts on both sides of the hollow rotor.

### New Multi Thread High-Helix Lead Shaft

The method and system may employ a multi thread high-helix lead shaft wherein its threads are in 45 degrees and hence capable of easily converting linear motion to rotary motion and vice versa.

Such shaft may be, as in some embodiments of the invention, be made of metal, stainless steel or aluminum while in further embodiments maybe formed using a cold rolling process. While in other embodiments of the invention, the shaft may be made of carbon or other composite material in order to minimize heating while moving (i.e. friction).

In some embodiments of the invention, the shaft may be adapted to operate with high pitch nuts made of various materials such as carbon, steel, other metals, ceramic, composite materials, thermoplastic, etc.

As can be appreciated, the method allows the length, diameter, amount and pitch of the shaft and nuts may be adapted to the waves condition and desired output.

In some embodiments of the invention, the shaft may be located in a protective pipe that may further be located in a mast and hence may allow the shaft larger freedom of vertical movement. In further embodiments of the invention, the movement may be such that may allow the shaft to partially exit from the top of the mast.

In some embodiments of the invention, the shaft, in the portion within the mast may move on a rail.

The multi thread high helix hollow shaft may allow usage without lubrication when fabricated from certain materials or combinations of hard compressed carbon, okolon, nylon, bronze, babbitt and stainless steel.

In some embodiments of the invention, the high helix shaft may move up and down all along the buoy.

In some embodiments of the invention, the high helix shaft may move freely in and through its matching nuts which may further be connected by bolts to a hollow rotor or rotors of the alternators or generators.

In further embodiments of the invention, the thread may have a plate connected to its lower end adapted to center and secure the shaft and the thread.

In some embodiments of the invention, the end of the thread may consist of a tightening thread that may be adapted to both secure and allow adjustability. The secured thread may not be able to turn or leave its predetermined position and location on the heave plate or the mono pole.

In some embodiments of the invention, the upper part of the multi-thread shaft may be held by two plates distanced from each other wherein each plate having two bearing on its upper and lower sides.

The bearing may be, as in some embodiments of the invention, lined with the twin rail installed inside the tower of the buoy in order to secure and align the thread in the shaft.

### Other Devices and Connectivity

In some embodiments of the invention, other devices rather then alternator and generator may make use of the bi-directional linear movement of the system. For example, water, air and oil pumps, compression pumps, compressors, etc.

For example, the buoy may allow connection to a submarine that may make use of the devices on a buoy to charge electricity, to fill compressed air tanks, to use the communication mast, etc.

### Heaves / Floating System / Mono Pole System

In some embodiments of the invention, the buoy may be connected to plates/heaves that may allow base stability to the buoy and may allow a mostly stable floating system.

In further embodiments of the invention, the buoy may be connected to any number of heaves constructed in predetermined distance from one another in manner that may allow layer of water to act as weight and balance the heave that may further be adjusted according to the water depth, etc.

In an embodiment of the invention, the heave may be a first layer filled with a predetermined quantity of sea water and a second layer filled with compressed air. Such may allow a non-symmetric response to waves and may increase stability.

In a further embodiment of the invention, the heave may have a rubber balloon that may allow piping, valves, etc. to float in order to allow easier access to content of the layers.

In an embodiment of the invention, such layers may be filled or emptied using the devices in the buoy, such as air and water pumps and compressors. Such may be controlled remotely. In other embodiments of the invention, such may be filled with materials such as polystyrene or other water resisting materials.

In a further embodiment of the invention, a second heave may be removably connected to a first heave whereby the second heave in located under the first heave and contain water. In some embodiments of the invention, any number of heaves may be connected in that manner.

In some embodiments of the invention, the heave may be constructed from a metal tubing or cylinders and may be connected to one another in a form of a metal cage.

In further embodiments of the invention, such cage may have engines that may allow positioning the cage using GPS and on or off-site control.

In further embodiments of the invention, two caged buoys with positioning engines may be connected with a net to allow collections of debris, such as plastic materials.

In further embodiments of the invention, the heaves may be remote controlled by human user or automated system in data communication with the buoy.

In further embodiments of the invention, the heaves may be secured to the seabed using buried sinkers that may allow limiting the movement of the heaves.

In an embodiment of the invention, the buoy control system may respond to dangerously high waves by changing the content of the heaves, plates and mono pole system or by deciding to sink the buoy until the danger passes. Such may be part of an automated process by the buoy control system or a remote decision of the remote user or system.

### Multi Stage Adjustable Telescopic Hollow Cylinder System

In an embodiment of the invention, the thread shaft may be housed in a multi stage adjustable telescopic hollow cylinder system that may, as in some embodiments of the invention, have a tide seal.

In some embodiments of the invention, the system may comprise any number of adjustable cylinders according to their height and the required total length of the shaft.

In further embodiments of the invention, the multi stage adjustable telescopic hollow cylinder system may be firmly connected in its bottom to a long metal pipe (mono pole system) that may be buried in the seabed and may have a flat top acting as a base and placed in a predetermined depth according the expected size of waves.

In further embodiments of the invention, the multi stage adjustable telescopic hollow cylinder system may be firmly connected in its top to the hull of the buoy. The connection may be achieved using a universal joint adapted to secure the cylinder to the buoy while allowing rotational movement of up to 260 degrees and angular movement of up to 100 degrees.

In some embodiments of the invention, the multi stage adjustable telescopic hollow cylinder, as it is harnessed in its bottom and top, create a venting and ventilation actions which may be harnessed to cycle air within the system with the air from outside the system and hence allow temperature control within the system. Further embodiments of the invention may allow a breathing system with valves and filters to prevent moisture and humidity from entering the system and allow moisture and humidity exit the system.

In some embodiments of the invention, a multi stage adjustable telescopic hollow cylinder may be connected to another multi stage adjustable telescopic hollow cylinder in order to allow longer connection. Such connection may be achieved by connecting the smallest diameter of the lower telescopic hollow cylinder to the smallest diameter second telescopic hollow cylinder or to the largest diameter of the second telescopic hollow cylinder.

In an embodiment of the invention, the system may allow entry of air from its upper part and hence does not create vacuum while movement. Such may also allow better cooling and removal of excess humidity, as fresh air is going into the inner part.

In some embodiments of the invention, the farm may make use of the heaves system in order to accommodate more buoys in a small area by using different depths.

### Buoy Modular Floating Metal Structure

In some embodiments of the invention, a floating metal structure may allow connection of any number of buoys and hence create a eco-friendly power farm.

The farm may be of any shape and size and may allow any relevant distance between the buoys.

The buoy may provide continuous supply of electricity to electric grid by storing excess electricity to said batteries and provide electricity from said batteries when not enough electricity is generated.

In some embodiments of the invention, the system may allow external holding to allow holding of further equipment. In several embodiments of the invention, such further equipment may be, for example, transformers to transform electric current to be used by electric motors. In some embodiments of the invention, such electric motors, air or oil compressors, etc. and may be such to allow independent movement of the buoy or number of removably connected cluster of buoys. In further embodiments of the invention, such moving buoys may be further equipped to allow cleaning of water by collecting and storing of debris, dirt and pollution form the sea such as oil, plastic waste, etc. Such system may be completely remote controlled.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1-22. (canceled)

23. A single-body point absorber electricity generating buoy having a rigid body housing; a multi-stage hollow cylinder; a multi-thread high helix shaft a combination of non-similar or partially-similar low rounds-per-minute permanent magnet alternator/generator; damping/heave plate and cooling and communication tower.

24. The buoy of claim 23 wherein said multi stage hollow cylinder house and guard said multi-thread high helix shaft.

25. The buoy of claim 23 wherein said buoy supply constant voltage.

26. The buoy of claim 23 wherein said buoy is turning said alternator/generator in two different directions, up and down.

27. The buoy of claim 23 further comprising batteries to store created electricity.

28. The buoy of claim 23 wherein said buoy provide continuous supply of electricity via underwater cable to an electric grid directly or by storing excess electricity to batteries on-shore and provide electricity from said batteries when not enough electricity is generated.

29. The buoy of claim 28 further wherein said supply of electricity was transformed from DC current to AC current.

20. The buoy of claim 23 wherein power capacity is between 10 watt to 500 watt.

31. The buoy of claim 23 wherein size is between 1 KW to 200 KW or from 300 KW to 1 MW.

32. The buoy of claim 23 wherein only the internal rotor of the magnetic alternator or generator is turned.

33. The buoy of claim 23 wherein said multi stage adjustable telescopic hollow cylinder system is firmly connected in its bottom to a said mono pole and is firmly connected in its top to said hull of said buoy.

34. The buoy of claim 23 wherein said multi stage adjustable telescopic hollow cylinder system is firmly connected in its bottom to at least one heave and the other side of the multi stage adjustable telescopic hollow cylinder system is firmly connected in its top to said bottom of the hull of said buoy.

35. The buoy of claim 23 wherein said shaft, in the portion within said mast move on a rail.

36. The buoy of claim 23 wherein said multi stage adjustable telescopic hollow cylinder, as it is harnessed in its bottom and top, create a venting and ventilation actions which may be harnessed to cycle air within the system with the air from outside the system.

37. The buoy of claim 23 wherein some of said generators turn while said shaft move upward, others turn while said shaft move downwards and others turn with any vertical movement of said shaft.

38. The buoy of claim 23 wherein said buoy have an external air and water tight enclosure with at least one section and at least one layer of enclosure.

39. The buoy of claim 23 wherein said buoy further have an external holding to allow holding of transformers to transform electric current to be used by electric motors, air or oil compressors or pumps and similar machinery and further allow independent movement of said buoy or number of removably connected buoys.

40. The buoy of claim 38 wherein said system is remote controlled.

41. The buoy of claim 38 wherein said transformers are adapted to transform said alternator’s or generator’s AC current to DC current that is provided to said electric motors.

42. The buoy of claim 23 wherein said buoy is part of a buoy cluster and said buoys are removably connected to one another.
